(19) United States
(12) Patent Application Publication
(10) Pub. No.: US 2016/0377258 A1
(43) Pub. Date: Dec. 29, 2016

(54) SPREAD LIGHT LENS AND LED STRIP LIGHTS HAVING SAME

(71) Applicant: Self Electronics Co., Ltd., Ningbo (CN)

(72) Inventors: Bozhang Xu, NINGBO (CN); Huangfeng Pan, NINGBO (CN); Zuping He, NINGBO (CN)

(73) Assignees: Wanjiong Lin, NINGBO (CN); Self electronics USA Corporation, NORCROSS (CN); Self Electronics Co., LTD.

(21) Appl. No.: 15/195,472

(22) Filed: Jun. 28, 2016

(30) Foreign Application Priority Data
Jun. 29, 2015 (CN) 201510364288.5

(51) Int. Cl. F21V 5/04; F21S 4/28; F21V 19/00

(52) U.S. Cl. CPC F21V 5/04; F21V 19/003; F21S 4/28; F21Y 2103/10; F21Y 2115/10; F21W 2131/305

(57) ABSTRACT

An LED strip light.

### RELATED APPLICATION

This present application claims benefit of the Chinese Application, CN201510364288.5, filed on Jun. 29, 2015.

### BACKGROUND

1. Technical Field

The present application relates to lighting devices, and more particularly to a spread light lens and LED strip lights having same to form uniform illumination in the illumination area.

2. Description of the Related Art

Light emitting diode (LED) is growing in popularity due to decreasing costs and long life compared to incandescent lighting and fluorescent lighting. LED lighting can also be dimmed without impairing the useful life of the LED light source.

Recently, a number of LED lighting apparatuses have been designed to replace the halogen apparatus, as well as other traditional incandescent or fluorescence lighting apparatuses. But, due to mediocre light output, LED used in the past was primarily limited to applications where only small surface areas were illuminated. Usually, the LED light apparatuses include at least one lens having unified specification in order to be convenient to centralized purchase and assembly and ensure uniform illumination along length direction of the LED light apparatuses. Otherwise, illumination region of the LED light apparatuses is larger than the illuminated area so as that light can fully cover the illuminated area. As a result, partial light emitted forward of the two ends of the LED light apparatuses is out of the illuminated area. Therefore, it is not benefit to take advantage of the emitted light. Moreover, the partial light will form spot in outside of the illuminated area which result in a poor light effects.

Therefore, it is necessary to provide the spread light lens and the LED strip light having the same to settle out the above art problem.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is an isometric view of an LED strip light according to an embodiment.

FIG. 2 is an isometric exploded view of the LED strip light of FIG. 1.

FIG. 3 is a cross section view of the LED strip light of FIG. 1 taken along a line of A-A.

FIG. 4 is an isometric view of the spread light lens of the LED strip light of FIG. 1.

FIG. 5 is a light path view of the spread light lens of FIG. 4.

### DETAILED DESCRIPTION

The present application is illustrated by way of example and not by way of limitation in the figures of the accompanying drawings. It should be noted that references to “an” or “one” embodiment in this application are not necessarily to the same embodiment, and such references mean at least one.

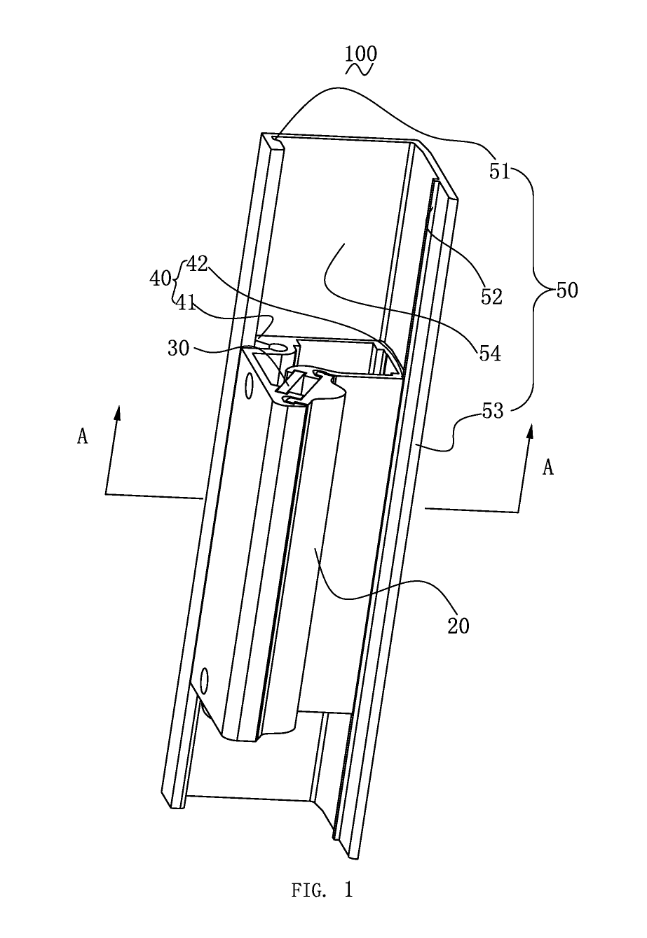

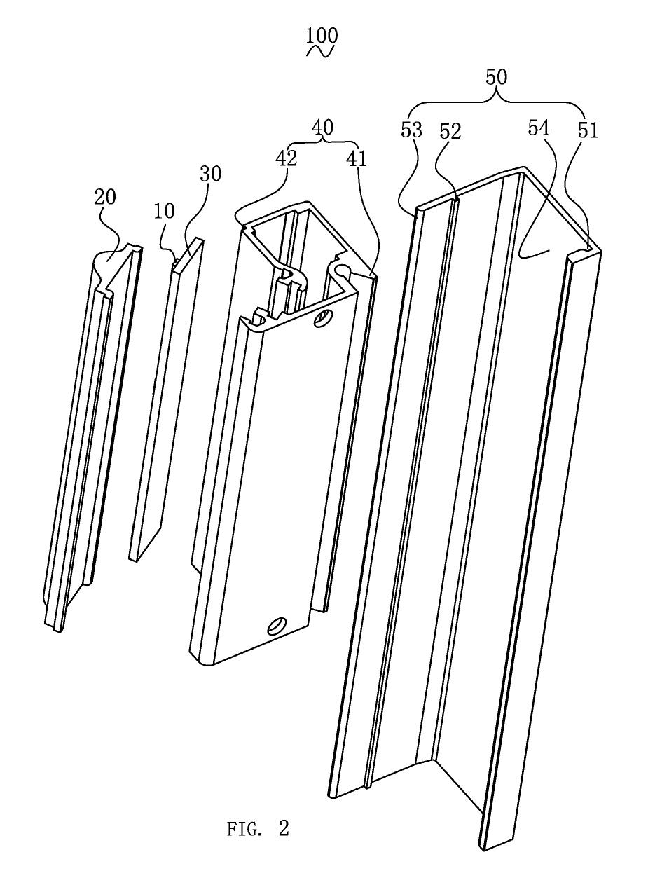

Referring to FIG. 1 and FIG. 2, an LED strip light 100 according to an embodiment is shown. The LED strip light 100 includes at least one LED chip 10, a spread light lens 20 arranged in emergent light of the LED chip 10, a printed circuit board 30 configured for disposing the LED chip 10, a strip-typed holder 40 configured for mounting the printed circuit board 30, and a base 50 configured for assembling the strip-typed holder 40. It may be understood that the LED strip light 100 further includes end covers, wires, LED drivers, and so on. These function modules are well known for an ordinary person skilled in the art, and not necessary to described in detail.

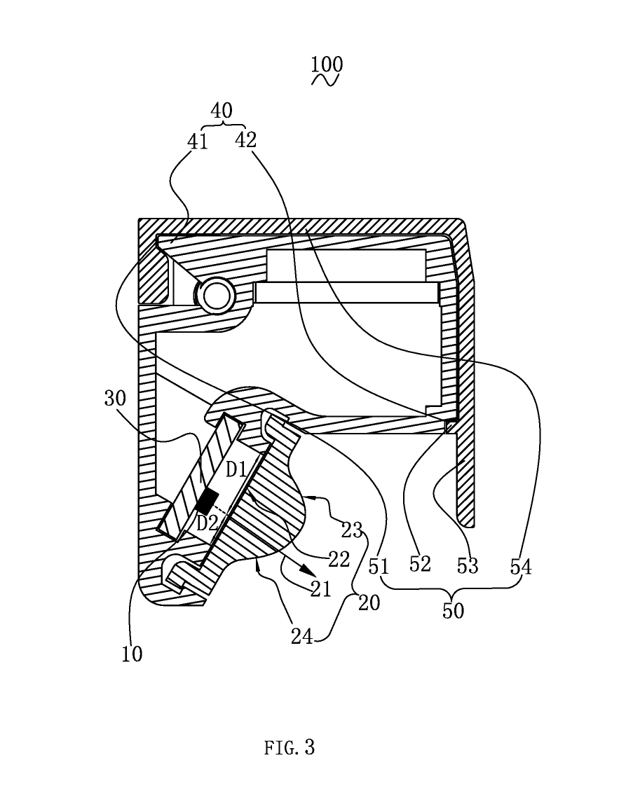

Referring to FIG. 3 together, the LED chip 10 is a semiconductor light source and transforms power into light. The LED chip 10 presents many advantages over traditional light sources including lower energy consumption, longer lifetime, improved physical robustness, smaller size, and faster switching. In the present embodiment, there are a plurality of LED chips 10 arranged on the printed circuit board 20, and light direction of the LED chips 10 is parallel to following optical axes 21 of a spread light lens 20. As well known, each of the LED chips 10 includes an LED optical axis 101.

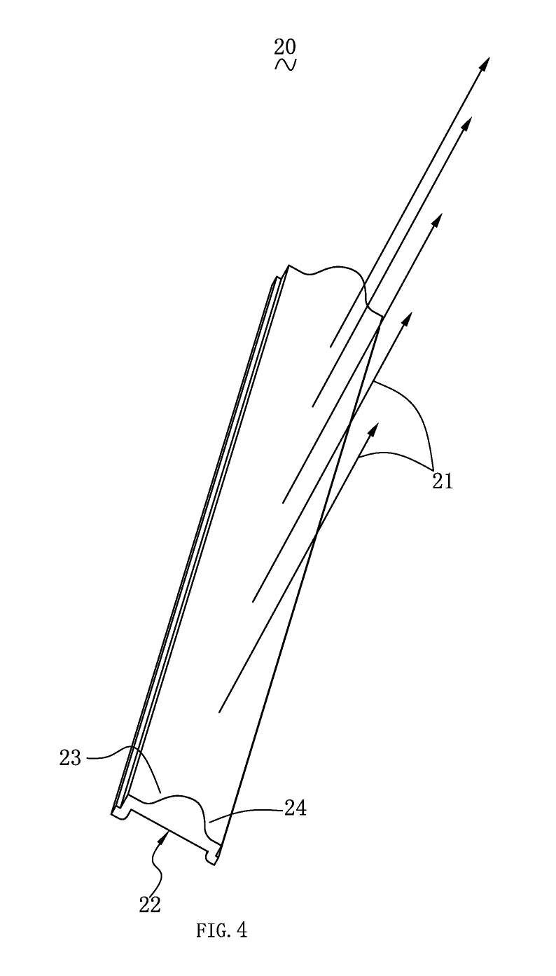

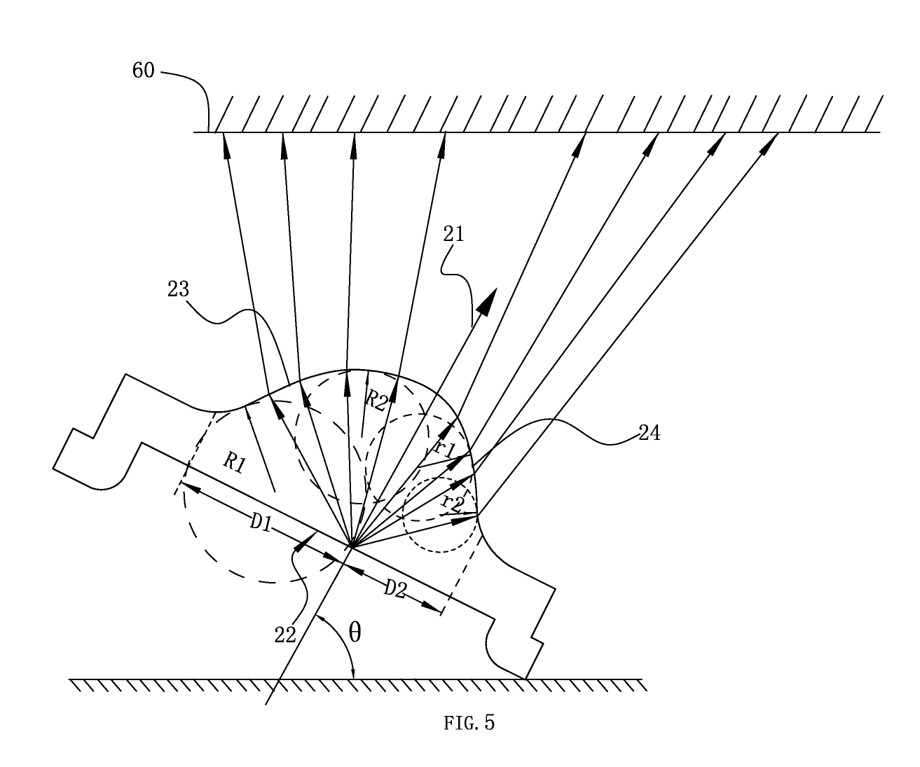

Referring to FIG. 4 together, the spread light lens 20 includes a plurality of optical axes 21, a light incidence surface 22 being perpendicular to the optical axes 21, a first convex light emitting surface 23, and a second convex light emitting surface 24. The spread light lens 20 may be made of transparent or semitransparent materials, such as glass, plastic, and so on. The plurality of optical axes 21 are arranged at identical interval. As well known, the optical axes 21 are universal feature for all of lens and used to dispose the light source, namely the LED chip 10. Moreover, the optical axes 21 are guide for optic design. In the present embodiment, one of the optical axes 11 is overlapped with one LED optical axis 101 of the LED chip 10. The light incidence surface 22 is configured for receiving the emergent light of the LED chips 10. In the present embodiment, the light incidence surface 22 is a plane so as to regulate the incident angle of incident light for optical design. The first convex light emitting surface 23 and the second convex light emitting surface 24 are positioned at both sides of the optical axes 21. As shown in FIG. 5, a radius R of curvature of a profile of the first convex light emitting surface 23 on a cross section taken along the optical axes 21 increases gradually towards a direction which is far away from the optical axes 21. Therefore, the radius R2 of curvature of the profile of the first convex light emitting surface 23 which is closer to the optical axes 21 is less than the radius R1 thereof which is father to the optical axes 21. On the other hand, a radius r of curvature of a profile of the second convex light emitting surface 24 on a cross section taken along the optical axes 21 decreases gradually towards a direction which is far away from the optical axes 21. Therefore, the radius r1 of curvature of the profile of the second convex light emitting surface 24 which is closer to the optical axes 21 is larger than the radius r2 thereof which is father to the optical axes 21. Furthermore, on the cross section taken along the optical axes 21, a projection of the first convex light emitting surface 23 on the light incidence surface 22 has larger length than that of the second convex light emitting surface 24 on the light incidence surface 22. As shown in FIG. 5, the length D1 of the projection of the first convex light emitting surface 23 is larger than the length D2 of the projection of the second convex light emitting surface 24. Therefore, The first convex light emitting surface 23 will receive more luminous flux than the second convex light emitting surface 24 so as to make up the intensity losses of attenuation because of larger irradiation distance. Furthermore, the radius R of curvature of the profile of the first convex light emitting surface 23 is larger than that of the second convex light emitting surface 24 on the cross section taken along the optical axes 21.

Referring to FIG. 3 to FIG. 5, in the present embodiment, the profile of the first convex light emitting surface 23 includes a plurality of arcs whose radius R of curvature is arithmetic progression. For example, the radius R of curvature of the profile may be 22 mm, 23 mm, 24 mm, and so on. In a similar way, the profile of the second convex light emitting surface 24 includes a plurality of arcs whose radius of curvature is arithmetic progression. For example, the radius r of curvature of the profile may be 16.5 mm, 17 mm, 17.5 mm, and so on. Further, the radius R of curvature of the profile of the first convex light emitting surface 23 is of 21 mm to 29 mm and the radius r of curvature of the profile of the second convex light emitting surface 24 is of 15 mm to 20 mm.

Referring to FIG. 1 to FIG. 3, the printed circuit board 30 is used to mount the LED chips 10 and supply power thereto. In the present embodiment, the printed circuit board 30 has a strip structure so as to mount the LED chips 10 along length direction thereof and form a strip luminous spot. About parameter and specification of the printed circuit board 30, it is not emphasis in the present embodiment and no need to describe in detail. Need to explain that two ends and middle part of the printed circuit board 30 are arranged along length direction thereof.

The strip-typed holder 40 is used to assemble the printed circuit board 30 by a method of clamping or locking. The strip-typed holder 40 is made of aluminous. In the present embodiment, the strip-typed holder 40 includes a plug 41 and a step 42. The plug 41 is configured for plugging into the base 50 and the step 42 is configured for clamping onto the base 50. The plug 41 may have a cross section of triangle wedge-shaped structure so as to be convenient to plug into the base 50. In order to further strong the stability of the base 50, the plug 41 and the step 42 may be disposed on the diagonal line of the strip-typed holder 40.

Referring to FIG. 1 and FIG. 2, the base 50 is configured for mounting the strip-typed holder 40 and includes a slot 51 and an arm 52. The slot 51 is configured for containing the plug 41 and the arm 52 is configured for supporting the step 42. Further, the base 50 includes an anti-glare bar 53 along the length direction of the strip-typed holder 40. The anti-glare bar 53 is configured for stopping the emergent light the first and second convex light emitting surface 23, 24 from getting into eyes of people. In the present embodiment, the anti-glare bar 53 is a plate and is integrated into the base 50. Furthermore, the base 50 includes an assembling surface 54. Understandably, the assembling surface 54 is used to assemble the LED strip light 100 on to building, such as wall space, desktop, and so on. In the present embodiment, the LED strip light 100 is assembled onto a door of a freezer. As shown in FIG. 5, an angle of the assembling surface 54 and the optical axes 21 is of 45 degrees to 75 degrees. In the present embodiment, the angle is 60 degrees.

In use, an emitting light of the first convex light emitting surface 23 should illuminate an illuminated area 60 which is closer to the LED strip light 100, and an emitting light of the second convex light emitting surface 24 should illuminate the illuminated area 60 which is father to the LED strip light 100, as shown in FIG. 5. Since the radius R of curvature of the profile of the first convex light emitting surface 23 is larger than that of the second convex light emitting surface 24 on the cross section taken along the optical axes 21, the second convex light emitting surface 24 has stronger convergence ability than the first convex light emitting surface 23. Further, since the radius of curvature of the profile of the first convex light emitting surface 23 increases gradually towards a direction which is far away from the optical axes 21, the convergence ability thereof will decreases gradually toward the same direction. On the other hand, since the radius of curvature of the profile of the first convex light emitting surface 24 decreases gradually toward a direction which is far away from the optical axes 21, the convergence ability thereof also will increase gradually towards the same direction. In result, although the light emitted from the first convex light emitting surface 23 may have smaller attenuation than the light emitted from the second convex light emitting surface 24 as the light emitted from the second light emitting surface 24 illuminate the illuminated area 60 which is farther to the LED strip light 100, light emitted from the second convex light emitting surface 24, which is father to the illuminated are 60, can make up the intensity losses of attenuation as the second convex light emitting surface 24 has stronger convergence ability. As a result, the illumination pattern which is closer to the LED strip light 100 has same luminance with the illumination pattern which is father to the LED strip light 100.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A spread light lens, comprising:
a plurality of optical axes, the optical axes been arrange in a line;
a light incidence surface being perpendicular to the optical axes;
a first convex light emitting surface arranged at interval with the light incidence surface, a radius of curvature of a profile of the first convex light emitting surface on a cross section taken along the optical axes increasing gradually towards a direction which is far away from the optical axes; and
a second convex light emitting surface arranged at interval with the light incidence surface, the first, second convex light emitting surfaces been arranged at both sides of the optical axes, a radius of curvature of a profile of the second convex light emitting surface on the cross section taken along the optical axes decreasing gradually towards the direction which is far away from the optical axes, the radius of curvature of the profile of the first convex light emitting surface being larger than that of the second convex light emitting surface on the cross section taken along the optical axes.

2. The spread light lens as claimed in claim 1, wherein on the cross section taken along the optical axes, a projection of the first convex light emitting surface on the light incidence surface has larger length than that of the second convex light emitting surface on the light incidence surface.

3. The spread light lens as claimed in claim 1, wherein the optical axes are arranged at identical interval.

4. The spread light lens as claimed in claim 1, wherein the profile of the first convex light emitting surface on the cross section comprises a plurality of arcs whose radius of curvature is arithmetic progression.

5. The spread light lens as claimed in claim 1, wherein the profile of the second convex light emitting surface on the cross section comprises a plurality of arcs whose radius of curvature is arithmetic progression.

6. The spread light lens as claimed in claim 1, wherein the profile of the first convex light emitting surface on the cross section is of 21 mm to 29 mm, the profile of the second convex light emitting surface on the cross section is of 15 mm to 20 mm.

7. An LED strip light, comprising:
a strip-typed holder;
a plurality of LED chips arranged on the strip-typed holder along length direction thereof; and
a spread light lens arranged on the emergent light of the LED chips, comprising:
a plurality of optical axes, the optical axes been arrange in a line;
a light incidence surface being perpendicular to the optical axes;
a first convex light emitting surface arranged at interval with the light incidence surface, a radius of curvature of a profile of the first convex light emitting surface on a cross section taken along the optical axes increasing gradually towards a direction which is far away from the optical axes; and
a second convex light emitting surface arranged at interval with the light incidence surface, the first, second convex light emitting surfaces been arranged at both sides of the optical axes, a radius of curvature of a profile of the second convex light emitting surface on the cross section taken along the optical axes decreasing gradually towards the direction which is far away from the optical axes, the radius of curvature of the profile of the first convex light emitting surface being larger than that of the second convex light emitting surface on the cross section taken along the optical axes;
wherein an emitting light of the first convex light emitting surface illuminate an illuminated area which is closer to the LED strip light, an emitting light of the second convex light emitting surface illuminate an illuminated area which is father to the LED strip light.

8. The LED strip light as claimed in claim 7, wherein each of the LED chips comprises an LED optical axis, the LED optical axis is overlapped with one of the optical axes.

9. The LED strip light as claimed in claim 7, wherein the LED strip light further comprises a printed circuit board configured for disposing the LED chips, and a base configured for mounted the strip-typed holder.

10. The LED strip light as claimed in claim 9, wherein the strip-typed holder comprises a plug and a step, the base comprises a slot for containing the plug, and an arm for supporting the step.

11. The LED strip light as claimed in claim 9, wherein the base further comprises an anti-glare bar along the length direction of the strip-typed holder.

12. The LED strip light as claimed in claim 9, wherein the base further comprises an assembling surface, an angle of the assembling surface and the optical axes is of 45 degrees to 75 degrees.
